(19) United States
(12) Patent Application Publication
(10) Pub. No.: US 2026/0286991 A1
(43) Pub. Date: Sep. 24, 2026

(54) MECHANISM FOR ONLINE CONTINUOUS PURIFICATION OF HYDRAULIC AND/OR LUBRICATING OIL USING AVAILABLE SYSTEM PRESSURE

(71) Applicant: Sheetal VATTURKAR, Pune (IN)

(72) Inventor: Sheetal VATTURKAR, Pune (IN)

(21) Appl. No.: 19/490,966

(22) PCT Filed: Feb. 3, 2024
(86) PCT No.: PCT/IN2024/050104

§ 371 Date: Dec. 8, 2025

(30) Foreign Application Priority Data
Jun. 24, 2023 (IN) 202321042375

(51) Int. Cl. F15B 21/041; F01M 1/02; F01M 1/10; F01M 1/16; F01M 11/03

(52) U.S. Cl. CPC F15B 21/041; F01M 1/02; F01M 1/10; F01M 1/16; F01M 11/03; F01M 2001/1028; F01M 2001/1071

(57) ABSTRACT

Disclosed herein is a mechanism (100B) for online continuous purification of hydraulic and/or lubricating oil using available system pressure. The said mechanism comprises an oil tank (101) containing hydraulic and/or lubricating oil, a high-pressure pump (102), a pressure line filter (103), a hydraulic/lubricating/transmission application (104), a return line filter (105), an air breather (106) and a purification device (107) which are functionally coupled with each other. The said mechanism cleans the hydraulic and/or lubricating oil to desired NAS/ISO quality and maintains the oil purity level, at all times i.e., during operation, with zero or almost negligible impact on existing performance. No additional pump or prime mover is required. The present disclosure uses all the available system parameters without any hidden add-ons. It is a light-weight, compact and easy-to-handle purification system which in the long run extends usage of oil, the full flow filter life and improves equipment up time.

### FIELD OF THE INVENTION

The present invention relates to mechanism for online or bypass continuous purification of hydraulic and/or lubricating oil. More particularly it relates to purification of hydraulic and/or lubricating oil using available system pressure with desired NAS quality i.e., purification without using any additional pump or any prime mover.

### BACKGROUND OF THE INVENTION

Hydraulics pressure is used for variety of applications to make work easy e.g., in automobile power steering to heavy duty equipment like excavator/dumper etc. These hydraulic applications get more precise for marine and aviation industry. Along with this, there are many industrial applications in steel, cement, power and gas industry.

Similarly, to hydraulics, lubrication individually and hydraulic cum lubrication together (e.g., Tractor Transmission) also uses oil as an important constituent on which system performance is dependent.

In both cases Hydraulic and/or lubricating circuit cleanliness of oil plays very crucial role. Contamination in oil (from 1-micron particles to 100-micron particles) has a direct impact on system performance.

Present full flow hydraulic filters (pressure line and/or return line) are installed but are not in position to get entire oil to required NAS/ISO class. Therefore, the available contamination in the circuit is responsible for wear and tear for some or all components in circuit. This wear increases the clearance and ultimately needs replacement of damaged components. At the same this wear creates an irreversible change in oil and ultimately needs oil replacement.

The cited prior art document (CN101865186A) titled “Online oil filling and purifying device for hydraulic equipment” reveals the online circulating purification system where the dirty oil pipeline and the absolute oil pipeline are respectively provided with a dirty oil pipeline quick connector and an absolute oil pipeline quick connector which are communicated with the oil tank of the hydraulic equipment; the dirty oil pipeline is communicated with the absolute oil pipeline through an isolation electromagnetic valve, a one-way valve and a gear pump; and a pressure filter is arranged in the absolute oil pipeline.

Also, the existing stationary hydraulic oil filtration/purification systems available in market are very heavy and huge in size. They are not easy to handle and operate for running equipment. It calls for high amount of time and cost if these to be used for periodic off line filtration.

The present disclosure uses the available system pressure for purification without usage of any additional pump or any additional prime mover. It is a light-weight, compact and easy to handle and operate purification system. Thus, the inventor of the present disclosure has mitigated the aforementioned drawbacks and limitation of existing hydraulic and lubricating oil purification systems by providing online or bypass purification mechanism for hydraulic and/or lubricating oil using same available pressure as that of system pressure.

The foregoing objects of the invention are accomplished and the problems and shortcomings associated with the prior art techniques and approaches are overcome by the present invention as described below in the preferred embodiment.

The detailed description of the present invention is followed herewith.

### OBJECT OF THE INVENTION

The main object of the present disclosure is to provide a mechanism for online continuous purification of hydraulic and/or lubricating oil using available system pressure without use of any additional pump or prime mover.

Yet another object is to reduce wear in component of any hydraulic or lubricating application and maintain oil quality to desired NAS/ISO/SAE quality.

Yet another object is to provide on Equipment Purification system, which continually cleans the oil during operation.

Yet another object is to provide light-weight, compact and easy-to-handle purification mechanism which will result in very low Hydraulic/transmission down time along with effective oil life extension.

### DEFINITIONS OF TERMS USED IN THE INVENTION

NAS: National Aerospace Standard

### SUMMARY OF THE INVENTION

A mechanism (100B) for online continuous purification of hydraulic and/or lubricating oil using available system pressure is disclosed herein. The said mechanism comprises an oil tank (101) containing hydraulic or lubricating oil or combination thereof, a high-pressure pump (102), a pressure line filter (103), a hydraulic or lubricating or transmission application thereof (104), a return line filter (105), an air breather (106) and a purification device (107) as the major embodiments, which are functionally coupled with each other. The purification device (107) further comprises a specially designed flow control valve (107A), a housing (107B) having fitted with surface or depth filter (107C) for filtration and purification and a high-pressure release valve (107D). The purification device (107) continuously works using available system pressure to deliver hydraulic and lubricating oil of desired NAS/ISO quality during the operation without using any additional pump or a prime mover. The said mechanism is a light-weight, compact and easy-to-handle purification mechanism which results in very low Hydraulic or transmission down time along with effective oil life extension.

### BRIEF DESCRIPTION OF DRAWINGS

These and other advantages are more readily understood by referring to the following detailed description disclosed hereinafter with reference to the accompanying drawing, definitions of terminologies used and which are illustrated hereinafter.

The figures provided herein are not necessarily to the scale, out of which:

FIG. 1: Shows the differentiating block diagram of existing purification mechanism (100A) and the said mechanism (100B) for the online continuous purification of hydraulic and/or lubricating oil using available system pressure

FIG. 2: Shows the block diagram to elaborate the components of the said purification device (107)

FIG. 3: Shows the graph of comparison between existing systems (100A) and the said mechanism (100B) using live field data.

FIG. 4: Shows the graph of comparative performance w.r.t. time with existing systems (100A) and with the said mechanism (100B).

### DESCRIPTION OF THE INVENTION

The features of the present invention and its technical advantages can be better understood from the following description of preferred embodiments together with the claims and accompanying schematic drawings. It is to be understood that this invention is not limited to the specific devices, methods, conditions or parameters described and/or shown herein and that the terminology used herein is for the example only and is not intended to be limiting of the claimed invention.

Also, as used in the specification, the singular forms ‘a’, ‘an’, and ‘the’ include the plural, and references to a particular numerical value includes at least that particular value unless the content clearly directs otherwise. The pronouns “his”, “him”, “their” and/or similar refer to the noun unless the content clearly directs otherwise.

The nouns are not case sensitive unless noted otherwise. Ranges may be expressed herein as from ‘about’ or ‘approximately’ to another particular value. Also, it is to be understood that unless otherwise indicated, dimensions and material characteristics stated herein are by way of example rather than limitation, and are for better understanding of sample embodiment of suitable utility, and variations outside of the stated values may also be within the scope of the invention depending upon the particular application. It is to be understood that the above description is intended to be illustrative, and not restrictive. The below discussed embodiments may be used in combination with each other. It will be apparent to those skilled in the art that the present invention may be practiced without these specific details.

It should be emphasized that the term “comprises/comprising” when used in this specification is taken to specify the presence of stated features, integers, steps or components but does not preclude the presence or addition of one or more other features, integers, steps, components or groups thereof. The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purpose only and not for the purpose of limiting the invention.

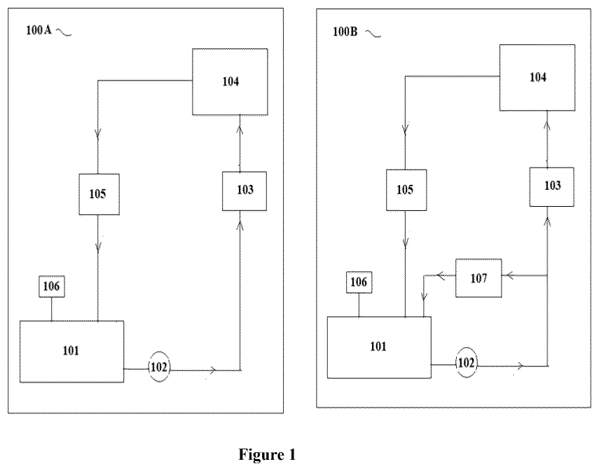

In accordance with the present invention, FIG. 1 shows the comparison between the functionality of existing purification mechanism (100A) and the said mechanism (100B) of present invention for online continuous purification of hydraulic and/or lubricating oil using available system pressure. Mentioned below is the working method of the present disclosure (100B) with various operational steps to implement the present disclosure.

The present disclosure of the mechanism (100 B) of online continuous purification of hydraulic and/or lubricating oil using available system pressure comprises an oil tank (101) containing hydraulic oil or lubricating oil or combination thereof, a high-pressure pump (102), a pressure line filter (103), a hydraulic or lubricating or transmission application thereof (104), a return line filter (105), an air breather (106) and a purification device (107) as the major embodiments which are functionally coupled with each other. The pressure line filter (103) and the return line filter (105) are the optional accessories.

The oil tank (101) contains hydraulic and/or lubricating oil or fluid which is either aqueous or viscous or organic in nature. This fluid or oil from tank (101) is pumped through high pressure pump (102). This high-pressure oil is passed through a pressure line filter (103) so as to protect costly valves and cylinders. This filtered oil goes to the said hydraulic or lubricating or transmission application (104) which contains valves, cylinders, etc. which is the function of whole intention of hydraulic circuit. Oil after utilization is returned to oil tank (101) via a Return line Filter (105) so as to further filter contamination generated in the operation. An air breather (106) is provided to the tank so as to feed and exhaust air through an air filter called Breather.

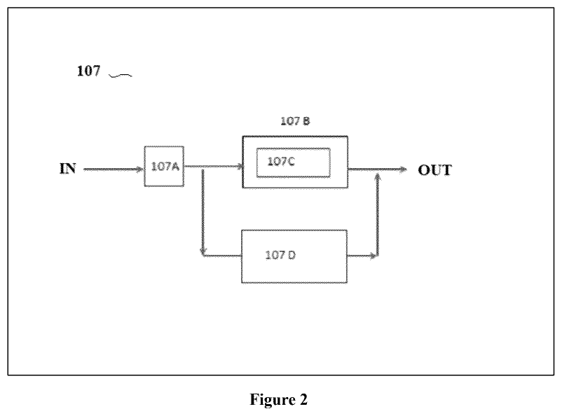

Referring to FIG. 2, the said purification device (107) further comprises a specially designed flow control valve (107A), the housing (107B) having fitted with surface or depth Filter (107C) for filtration and purification and a high-pressure release valve (107D). Pressurized Oil enters a specially designed flow control valve (107A) which is a high-pressure Flow control Valve. This valve (107A) regulates the oil flow in such a way that it has zero or negligible impact on Hydraulic or lubricating oil performance. This regulated flow oil enters the housing (107B). Oil goes to depth filter (107C) or a surface filter suitable for viscous/aqueous fluids i.e., oil for control of NAS/ISO quality. The high-pressure release valve (107D) is provided for safety of filter element for avoiding over pressurization.

As shown in FIG. 1 and FIG. 2, this purification device (107) continuously purifies oil and works using available system pressure to deliver hydraulic and/or lubricating oil of desired NAS/ISO quality during the operation without using any additional pump or a prime mover. The said purification device (107) is a light-weight, compact and easy-to-handle purification mechanism which results in very low Hydraulic or transmission down time along with effective oil life extension.

Please find following table to understand amount of contamination passing through system in one year. Higher NAS value is high contamination (i.e., lesser clean oil) and lower NAS value is lesser contamination (i.e., more clean oil).

(Basis of calculation: 100 lpm pump, operation 24 hrs. per day and for 365 days).

TABLE 1
NAS Value and respective contamination reduction

| NAS | | | |
|---|---|---|---|
| value | mg/lit | kg/Year | % reduction |
| 12 | 20 | 1051.2 | 0.0% |
| 11 | 10 | 525.6 | 50.0% |
| 10 | 5 | 262.8 | 75.0% |
| 9 | 3 | 157.68 | 85.0% |
| 8 | 1 | 52.56 | 95.0% |
| 7 | 0.5 | 26.28 | 97.5% |
| 6 | 0.2 | 10.512 | 99.0% |
| 4 | 0.1 | 5.256 | 99.5% |

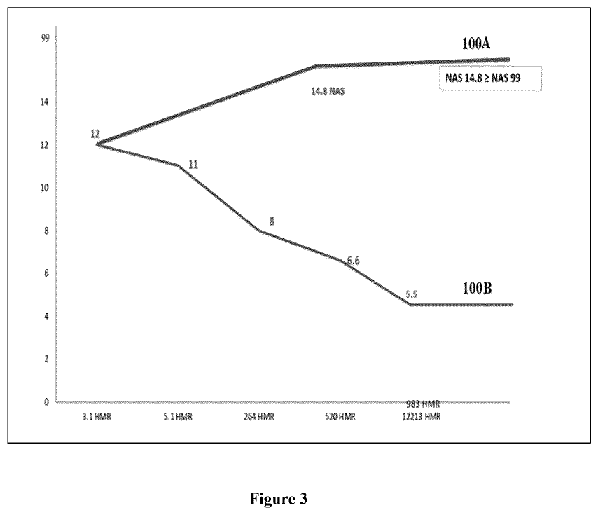

Referring to FIG. 3, which is a graphical representation for data analysis of live field data of existing hydraulic and/or lubricating oil systems vs presents disclosure. Red line in the graph represents the NAS level attained by existing systems (100A) while the blue line in the graph represents the NAS level attained by the said mechanism (100B) of present disclosure comprising the said purification device (107). It is evident from the FIG. 3, that the NAS value attained by using existing purifications systems (100A) increases with the usage of hydraulic or lubricating systems. This means the amount of contamination continues to build in the system. On the other hand, blue line represents the NAS quality in the said mechanism (100B) of hydraulic and/or lubricating system comprising the said purification device (107).

From the Table 1 above, it is clear that the higher the NAS value, the lesser is the purification attained. This further gives inference that the desired purification level is not obtained by existing purification systems (100A). But the present disclosure (100B) achieves the desired NAS value (desired purification level) for the same live sample data or field data.

The present disclosure confirms, for any hydraulic and/or lubrication system with operating pressure say in the range from 10 kg/cm² to 500 kg/cm², the functional performance even with the said purification device (107) of the said mechanism (100B) as disclosed herein. With this small flow which is in the range of 0-10% of total system flow, the said mechanism (100B) continuously purifies the oil to desired NAS/ISO quality and also maintains at this quality during running of main Hydraulic/transmission, lubricating system, with zero or almost negligible impact on existing performance.

The lubricant demand in India (as in year 2021 as per source Kline & co) is given below:
a. Consumer Automotive Application=500,000 Tons/Annum
b. Commercial Automotive Application=800,000 Tons/Annum
c. Industrial Application=1,600,000 Tons/Annum

The Industrial Applications include hydraulic, lubricating, Gear, Neat Cutting and other misc. applications. Predominantly, in case of hydraulic, lubricating and Gear applications, the oil removed goes to recycle with 10% quantity and rest 90% is simply burnt out.

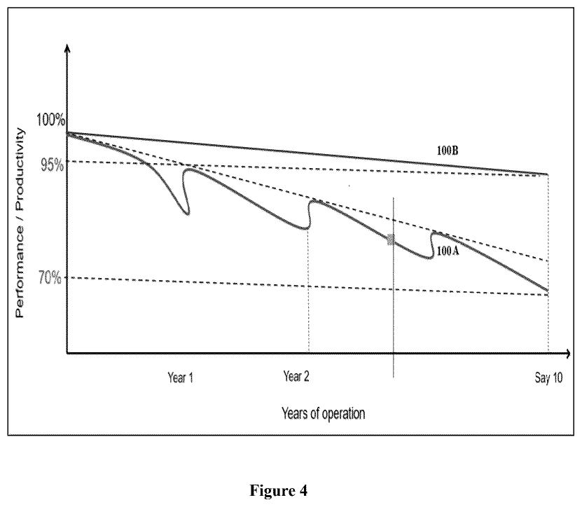

Referring to FIG. 4, which is a graphical representation showing comparative reduction in performance with Time using existing systems (100A) and with the said mechanism (100B). The blue line indicates the productivity attained by using existing system (100A) which is e.g., 70% whereas the violet line indicates productivity attained by using the said purification mechanism (100B) which is e.g., 95% for the same period of time. It is evident from the graph that the said purification mechanism (100B) enables the end-user acquire stable, uniform and consistent performance with increase in the productivity as compared to the existing system (100A). This further confirms that the said purification mechanism (100B) cleans and purifies oil to a great extent which reduces wear and tear of the components and thus improves the performance 10 or more times directly resulting into low maintenance of equipment implying improved effective life of equipment.

A non-limiting embodiment of accessing the present disclosure is mentioned above. The sequence of the steps provided herein above may change in other embodiments of the method of the present disclosure.

The embodiments described herein above for the said mechanism of online purification of hydraulic and/or lubricating oil using system pressure are non-limiting. The foregoing descriptive matter is to be interpreted merely as an illustration of the concept of the present disclosure and it is in no way to be construed as a limitation. Description of terminologies, concepts and execution steps known to persons acquainted with technology has been avoided to preclude beclouding of the afore-stated embodiments.

The foregoing objects of the invention are accomplished and the problems and shortcomings associated with prior art techniques and approaches are overcome by the present invention described in the present embodiment. Detailed descriptions of the preferred embodiment are provided herein; however, it is to be understood that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or matter.

I claim:

1. A mechanism (100B) for online continuous purification of hydraulic and/or lubricating oil using available system pressure, the mechanism comprising:
a) an oil tank (101) wherein oil is either hydraulic oil or lubricating oil or combination thereof;
b) a high-pressure pump (102);
c) a pressure line filter (103);
d) an application (104) wherein the application is either hydraulic or lubricating or transmission or combination thereof;
e) a return line filter (105);
f) an air breather (106); and
g) a purification device (107) comprising functionally coupled embodiments:
i. a flow-controlled valve (107A) for delivering regulated steady flow using all system parameters;
ii. a housing or a filter element (107B) having depth filter (107C) or a surface filter for filtration and purification; and
iii. a high-pressure release valve (107D) for avoiding over pressurization;
characterized in that
h) the pressure line filter (103) and the return line filter (105) are the optional accessories;
i) the air breather (106) is an air filter which is provided to the oil tank (101) to feed and exhaust the air;
j) the oil after utilization is returned to the oil tank (101) via return line filter (105);
k) the purification device (107) is a light-weight, compact and easy to handle device;
l) the purification device (107) continuously purifies the oil returned to the oil tank (101) after utilization with contamination generated in the operation, by using available system pressure for delivering hydraulic and/or lubricating oil of desired NAS or ISO quality during the operation without using any additional pump or a prime mover;
m) the flow-controlled valve (107A) regulates the oil flow in such a way that it has zero or negligible impact on Hydraulic or lubricating performance;
n) the depth filter (107C) or a surface filter is for filtration and purification of contaminated oil to attain the desired NAS or ISO quality of oil purification;
o) the high-pressure release valve (107D) is designed for avoiding over pressurization which provides safety to the filter element (107B).

2. The mechanism (100B) for online continuous purification of hydraulic and/or lubricating oil using available system pressure, as claimed in claim 1, wherein the said mechanism (100B) with the purification device (107) is a light-weight, compact and easy-to-handle purification mechanism which results in very low hydraulic or transmission down time along with effective oil life extension.

3. The mechanism (100B) for online continuous purification of hydraulic and/or lubricating oil using available system pressure, as claimed in claim 1, wherein the said mechanism (100B), with a small flow which is in the range of 0-10% of total system flow, continuously cleans the oil to desired NAS or ISO quality and also maintains this quality during running of main hydraulic or lubricating system, with zero or almost negligible impact on existing performance.

4. The mechanism (100B) for online continuous purification of hydraulic and/or lubricating oil using available system pressure, as claimed in claim 1, wherein the said mechanism (100B) cleans and purifies oil to a great extent which reduces wear and tear of the components and thus improves the component life ten or more times directly resulting into low maintenance of equipment implying improved effective life of equipment.

5. The mechanism (100B) for online continuous purification of hydraulic and/or lubricating oil using available system pressure, as claimed in claim 1, wherein the said mechanism (100B) continuously supplies purified and clean oil during operation which reduces the oxidation of oil resulting into increase in the effective life of oil which is in the range of minimum two to ten times of that provided by the existing systems (100A).
